(19) United States
(12) Patent Application Publication
(10) Pub. No.: US 2018/0374097 A1
(43) Pub. Date: Dec. 27, 2018

(54) A DISTRIBUTED USER PROFILE IDENTITY VERIFICATION SYSTEM FOR E-COMMERCE TRANSACTION SECURITY

(71) Applicant: Roger HANNA, Currumbin Waters (AU)

(72) Inventor: Roger HANNA, Currumbin Waters (AU)

(21) Appl. No.: 16/063,562

(22) PCT Filed: Nov. 9, 2016
(86) PCT No.: PCT/AU2016/051071

§ 371 Date: Jun. 18, 2018

(30) Foreign Application Priority Data
Nov. 9, 2015 (AU) 2015904591

(51) Int. Cl. G06Q 20/40; G06Q 20/38; H04L 9/32; H04L 29/06; H04L 29/08; H04L 9/06

(52) U.S. Cl. CPC G06Q 20/4014; G06Q 20/3823; H04L 9/3236; H04L 9/3247; G06Q 50/01; H04L 67/306; H04L 9/0637; H04L 2209/38; H04L 63/123

(57) ABSTRACT

A distributed user profile identity verification system comprising: has at least one authentication server; a distributed blockchain identity verification ledger comprising a plurality of synchronised distributed identity verification databases, each database comprising unique user profile identifier records and associated verification level records. The authentication server is configured for identity verification of an online user profile by creating a user profile record for the online user profile in the ledger which has a unique user profile identifier and an associated first verification level. Upon successful completion verification tasks, the authentication server pushes verification level blockchain update records to the ledger which are linked to the user profile record and cryptographically signed by the authentication server. Therefore when subsequently verifying the online user profile, the distributed block chain identity verification ledger may be queried with the unique user profile identifier to retrieve the current verification level.

### FIELD OF THE INVENTION

The present invention relates to a distributed user profile identity verification system.

### SUMMARY OF THE DISCLOSURE

According to one aspect, there is provided a distributed user profile identity verification system comprising: at least one authentication server; a distributed blockchain identity verification ledger comprising a plurality of synchronised distributed identity verification databases, each database comprising unique user profile identifier records and associated verification level records, wherein, in use: the least one authentication server is configured for identity verification of an online user profile by creating a user profile record for the online user profile in the ledger, the user profile record comprising a unique user profile identifier and an associated first verification level, subsequently performing a verification task; and upon successful completion of the verification task, pushing an verification level blockchain update record to the ledger, the verification level blockchain update record comprising a second verification being greater than the first verification level, the verification level blockchain update record linked to the user profile record and cryptographically signed by the authentication server.

The authentication server may be configured for generating the unique user profile identifier.

The unique user profile identifier may be generated using a hash algorithm.

The hash algorithm has as input at least one of user identification data and social graph data.

The verification task may comprise receipt of user identification data.

The user identification data may comprise email address data.

The verification task may comprise verifying the email address data using an email verification message.

The verification task may comprise receipt of social user account data.

The verification task may comprise authenticating with a social media server associated with the social user account data.

The verification task may comprise retrieval of social graph data from a social user account associated with the social user account and wherein the verification task has as input the social graph data.

Each database may further comprise user data.

The at least one authentication server allows for user control of user data.

User control of the content user data may comprise configuring a publication setting.

The publication setting configures the user data to be visible only to other users having a user profile record within the ledger.

The publication setting configures the user data to be visible only to other users having a user profile record having a minimum verification threshold level within the ledger.

The system may be configured for receiving a user identity verification request and responding with a user identity verification response comprising at least a verification level.

Responding with a user identity verification response may comprise serving a verification icon representing the verification level.

The user identity verification request may comprise receiving a user profile identifier.

The user profile identifier may comprise a user profile page identifier.

The user profile identifier may further comprise a user profile page web domain.

The least one authentication server may be configured for user configuration of the serving of the verification icon by web domain.

The system may further comprise at least one authentication server in operable communication with the ledger and wherein the authentication server may be configured for receiving a user authentication request comprising a user profile identifier and searching for a matching user profile record within the ledger.

The authentication server may be further configured for retrieving the verification level associated with the matching user profile record and authenticating in accordance with the verification level.

Other aspects of the invention are also disclosed.

### BRIEF DESCRIPTION OF THE DRAWINGS

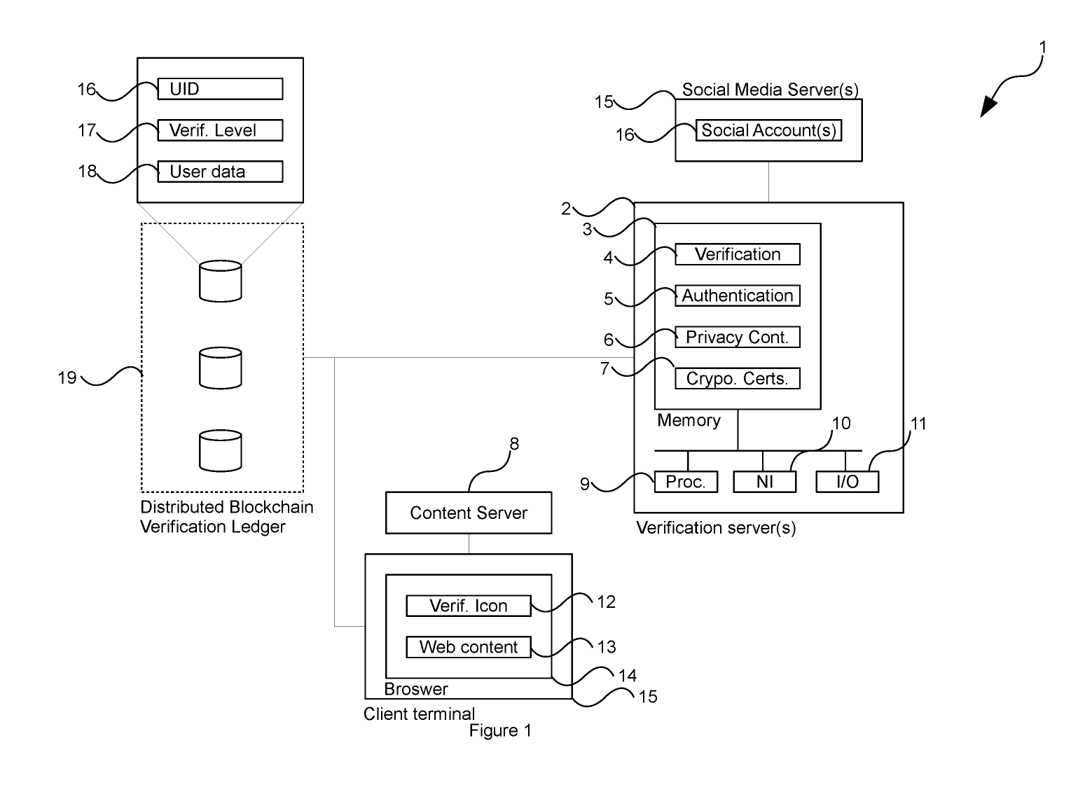

Notwithstanding any other forms which may fall within the scope of the present invention, preferred embodiments of the disclosure will now be described, by way of example only, with reference to the accompanying drawings in which FIG. 1 shows A distributed user profile identity verification system in accordance with an embodiment of the present disclosure.

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to the online user profile identity verification system are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

### Online User Identity Verification System

FIG. 1 shows a distributed user profile identity verification system 1 in accordance with an embodiment. As will be described in further detail below, the system 1 provides an online user profile identity verification and, in embodiments, authentication, so as to create a trusted online environment for enabling secure e-commerce transactions and other online transactions. As will be described in further detail below, the system 1 is configured for verifying user identity such that such verified user identity may be subsequently used when transacting online.

As can be seen, the system 1 comprises at least one verification server 2. The verification server 2 is configured for implementing the various user identity verification steps described herein and, in embodiments, authenticating verified users during subsequent online transactions.

The server 1 takes the form of a physical or virtualised computer server in operable communication with a plurality of client computing devices across a data network, such as the Internet. As can be seen, the verification server 2 may comprise a processor 9 for processing digital data. In operable communication with the processor across a system bus is a memory device 3 configured for storing digital data include computer program code. As such, during execution of the functionality described herein, the processor 9 retrieves computer code instructions from the memory device 9 for execution and wherein data results may be stored within the memory device 3. In embodiments, the memory device 3 may take on differing forms of memory devices including combinations thereof including volatile RAM memory and nonvolatile HDD storage.

As is illustrated in FIG. 1, the memory device 3 may be provided with a plurality of software modules so as to configure the verification server 2 specifically for implementing certain of the functionality described herein. As can be seen, the software modules comprise at least an online user identity verification module 4, and authentication module 5 and a privacy control module 6. The memory 3 may further be provided with cryptographic public/private key certificates 7 for digital signing purposes and the like.

The server 2 may further comprise a network interface 10 for sending and receiving data across the data network. Furthermore, the verification server 2 may further comprise an I/O interface 11 configured for transmitting data between at least one computer peripheral, such as datastorage peripherals, such as USB devices, user interface devices such as pointer and keyboard devices, display devices and the like.

As can be further seen from FIG. 1, at least one client terminal 15 may be in operable communication with the verification server 2 so as to allow users to interact with the verification server 2.

In embodiments, the client terminal 15 may execute a web browser application 14 wherein the system 1 takes a webserver architecture. In this regard, the verification server 2 may comprise a webserver application for serving dynamically generated content to the browser application 14 of the client terminal 15. However, it should be noted that in other embodiments, the client terminal 15 may take the form of a mobile communication device, such as a smart phone such as Apple™ iPhone™ device or the like wherein the mobile communication device executes a software application configured to implement the functionality described herein.

### Verification Levels

Now, as alluded to above, the system 1 is configured for verifying online user identity. As such, as can be seen, the software modules of the verification server 2 may comprise a verification module 4 configured to implement the online user identity verification.

For the purposes of being verified, new users would, utilising the client terminal 15, register with the verification server 2.

In a preferred embodiment, the system 1 verifies online users in accordance with incremental verification levels. In particular embodiment, the system 1 may verify online users in accordance with 10 verification levels of increasing verification stringency. As such, subsequent online transactions may be enabled depending on the verification levels of users. For example, certain financial transactions may be permissible only for users having a minimum threshold verification level.

As such, during initial registration with the verification server 2, new online users may be allocated a default verification level, such as level 0 or 1. Thereafter, as users complete various identity verification tasks, the verification level is incremented up to the maximum amount, being 10 in this example.

In particular embodiments, verification may initiate with straightforward verification tasks such as provision of identification information, such as name, address, email addresses and the like.

Such information may be accepted initially without verification but subsequently with further verification for subsequent verification levels. For example, email addresses may be tested by sending tests emails to the provided email address, codes sent to telephone numbers, unique codes posted to street address, utility bills inspected (such as by utilising image recognition) to verify the provided address and the like.

Further verification levels may utilise social media accounts. Specifically, as can be seen, the system 1 may communicate with a plurality of social media servers 15 comprising a plurality of social media accounts 16 for the online users.

As such, for increased verification levels, users may be required to provide unique social media account identification information, such as a unique username for at least one social media accounts 16. In further embodiments, the verification server 2 may require the online user authenticate via the social media server 15 wherein, to complete a verification stage, the verification server 2 redirects the browser application 14 to a URL served by the social media server 15 wherein the user may input their social media credentials such that the social media server 15 may indicate to the verification server 2 whether the social media credentials are correct. For example, to increase their verification level, the verification server 2 may require that users authenticate with the verification server 2 utilising their Facebook, LinkedIn, Gmail accounts or the like.

In further embodiments, further verification levels may inspect social graph data retrieved from the social media server 15. For example, when authenticating with the verification server 2 via the Facebook social media server 15, the verification server 2 may retrieve various information relating to the online uses contacts to verify whether the social media account 16 is genuine, such as by inspecting the number of friends, the age of the social media account, the frequency of posts, logins and the like.

In further in embodiments, the system 1 allows for verification of user identity by other verified online users. For example, when utilising social media account 16 for the purposes of incrementing a verification level of a user, the verification server 2 may ascertain that one of the social connections of the user is already verified with the system 1. In one embodiment, the system 1 may perform the verification on account of the existence of other verified users such as within the social graph of the user or alternatively may automate the sending of a query (such as by way of automated email) to the user to verify the user's identity.

Each online user may choose the verification level attained. Furthermore, the verification level attained by each online user may be indicated to each online user by way of a verification icon which may be displayed to the online user in different colours depending on the verification level.

### Distributed Block Chain Verification Ledger

Whereas in embodiments, the verification level allocated to users may be stored within the memory device 3 of the verification server 2, in a preferred embodiment, the verification levels are distributed across a distributed block chain verification ledger 19.

As such, as can be seen, the distributed block chain verification ledger 19 may comprise a plurality of databases which are synchronised with the various verification information. Different computing actors of the system 1 may each maintain a copy of the database, such as the social media servers 15, verification servers 2 and the like. In further embodiments, a computer may retrieve data from the distributed block chain verification ledger 19 as required without necessarily retaining a copy of the ledger.

As can be seen, the distributed block chain verification ledger 19 may comprise various information including a unique user ID 16, the verification level 17 associated with the user identified by the unique user ID and personal data 18.

The unique user ID 16 is utilised by the ledger 19 to uniquely identify online users. In one embodiment, the unique user ID 16 may take the form of an email address, social media account username or the like. In further embodiments, the verification server 2 may generate a unique user ID or signature dynamically for each user.

For example, the verification server 2 may generate a unique user signature utilising a hash algorithm or the like taking as input various information including user identification information, such as name, email address, residential address and the like. Ideally, the unique user ID generated for each user is globally unique so as to avoid collisions with other user unique IDs and is further immutable so as to not change over time.

In embodiments, each user profile record may comprise a plurality of unique user IDs 16 so as to allow differing systems to utilise the ledger 19 such as wherein, for example, a user is identified by both a Facebook username and a LinkedIn profile username.

The distributed block chain verification ledger 19 may be transactional in nature wherein, the first time a user ID 16 is added to the ledger 19, a user record creation transaction is recorded within the ledger 19 by the verification server 2 performing the verification. For example, the verification server 2 may digitally sign the initial user entry when placing the user entry onto the distributed ledger 19 so as to verify the entry by the verification server 2. In embodiments, the user record creation transaction may identify the verification server 2 having created the record.

For example, when first registering with the verification server 2, the verification server may create a unique hash signature/ID for the user taking into account various information such as user identification information, social media account information and the like. Thereafter, the verification server 2 may search the ledger 19 for the unique user signature/ID wherein, if not found, the verification server 2 would create a new user entry comprising the unique user signature/ID and the initial verification level, being zero or 1 for the initial verification level. The verification server 2 may digitally sign the initial entry and create a first block for the user record chain in the verification ledger 19. The signing of the initial entry by the verification server 2 utilising the cryptographic key 7 allows only the verification server 2 to create user records within the distributed ledger 19.

Thereafter, updates to the user record within the block chain ledger 19 may be further chained so as to chain together the user updates/transactions from initial user entry. For example, should the user attain a further verification level, the further verification level would be pushed to the distributed ledger 19 and digitally signed to be linked to the previous block in the user data.

Various user data 18 may further be pushed to the verification ledger 19. The user data 18 may comprise various data fields for storing various user data 18. In this manner, updates to the user data 18 may be further pushed to the distributed block chain by way of digitally signed block chain updates.

In embodiments, users may control the user data 18 stored such as by utilising the functionality provided by the privacy control module 6. In further embodiments, users may control the visibility of such data wherein, for example, certain information may be accessible only to only other verified users within the block chain 19.

In embodiments, querying of the user identity information stored within the ledger 19 may be further recorded within the block chain wherein, for example, the request for verification of a first user by a second user would be recorded within the block chain such that the first user may view the identity verification request of the second user. Similarly, accessing of public or private data by the second user may be recorded for later inspection by the first user.

Now, for the purposes of verifying users for online transactions, the distributed ledger 19 may be queried. For example, when transferring electronic funds to a second user, a first user may initially query the ledger 19 to ascertain whether the second user is verified and, in embodiments to what level. Such user verification may be automated wherein, for example, when transferring funds between accounts, such as PayPal accounts, the PayPal server may automate a background process to inspect the ledger 19 to verify the user identities. Should the PayPal detect that the user does not have the requisite verification level threshold, a warning may be displayed to funds transferrer or the transaction may be blocked.

For the purposes of querying the ledger 19 by users, unique user identification may be provided of the second user by the first user, such as the email address of the second user or the like. The ledger 19 may then respond if a record is found matching the email address and the verification level 17. For example, when transferring electronic funds, the user may input the email address provided for the recipient PayPal account so as to view the verification level of the recipient user.

In further embodiments, a verification icon 12 may be provided representing the verification level of users 17. For example, when serving content from a content server 8, a social media server 15 or the like relating to a user, the verification icon 12 may be superimposed on such content such that other users may view the verification level of the user.

For example, on a public Facebook page provided by a user, the verification icon 12 may be superimposed by the Facebook social media server 15 to attest to the verification level or trustworthiness of a user. As such, for example, when deciding whether to trust a first user for an online financial transaction, a second user may view the public Facebook profile page of the first user to view the trustworthiness of a first user. Furthermore, such a verification icon 12 may be provided on the public PayPal profile page of the recipient user. As alluded to above, the displayed verification icon 12 may be displayed in differing colouring depending on the verification level of the relevant user. As such, the browser 14 may retrieve the web content from the content server 8 or the social media server 15 and the verification icon 12 content from another server, such as the verification server 2.

In embodiments, as opposed to displaying the verification level within web content 15, the browser 14 may be configured to display such a verification. For example, when viewing a public Facebook profile page of the first user, the browser 14, by identifying the Facebook URL may then query the verification ledger 19 so as to be able to display a browser notification indicating the trust level of a user. Furthermore, the browser 14 may dynamically inspect web requests so as to, for example, on a PayPal payment page (identified by the domain), the browser 14 may inspect an email address of a recipient PayPal user so as to be able to provide substantial real-time feedback to a user as to the trustworthiness of the recipient. For example, when requesting to transfer funds to a recipient user, the browser may dynamically display a notification stating “the recipient is not trusted for financial transactions, do you wish to continue?”. In such case, the user may request that the recipient user perform further verification prior to reinitiating the funds transfer request.

In embodiments, a user may configure which user profiles are able to be verified wherein, for example, a user may configure the verification server 2 such that the system 1 is able to provide verification icon 12 indications to other users for the Facebook and Linked In public profile pages of the user but not for the users Twitter account for example.

### Secure Authentication

In embodiments, the system 1 may be utilised for secure authentication for sensitive web resources utilising the authentication module 5.

For example, when authenticating with a sensitive online banking account for example, the online banking account may require that the user authenticate via the verification server 2 (or other authentication server having access to the verification ledger) such as by way of browser redirect or the like. As such, when authenticating with an online banking account, the browser 14 may redirect to an authentication resource served by the verification server 2 allowing the user to authenticate with the verification server 2, wherein, one successfully authenticated, the browser 14 then redirects to the secure online banking resource wherein the banking resource may be provided with a cryptographic key verifying the authentication by the verification server 2.

### Interpretation

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, FIGURE, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the online security industries.

1. A distributed user profile identity verification system comprising:
at least one authentication server;
a distributed blockchain identity verification ledger comprising a plurality of synchronised distributed identity verification databases, each database comprising unique user profile identifier records and associated verification level records, wherein, in use:
the least one authentication server is configured for identity verification of an online user profile by creating a user profile record for the online user profile in the ledger, the user profile record comprising a unique user profile identifier and an associated first verification level,
subsequently performing a verification task; and
upon successful completion of the verification task, pushing a verification level blockchain update record to the ledger, the verification level blockchain update record comprising a second verification level being greater than the first verification level, the verification level blockchain update record linked to the user profile record and cryptographically signed by the authentication server and, wherein, for subsequently verifying the identity of the online user profile, the distributed block chain identity verification ledger may be queried with the unique user profile identifier to retrieve the second verification level.

2. A distributed user profile identity verification system as claimed in claim 1, wherein the authentication server is configured for generating the unique user profile identifier.

3. A distributed user profile identity verification system as claimed in claim 2, wherein the unique user profile identifier is generated using a hash algorithm.

4. A distributed user profile identity verification system as claimed in claim 3, wherein the hash algorithm has as input at least one of user identification data and social graph data.

5. A distributed user profile identity verification system as claimed in claim 1, wherein the verification task comprises receipt of user identification data.

6. A distributed user profile identity verification system as claimed in claim 5, wherein the user identification data comprises email address data.

7. A distributed user profile identity verification system as claimed in claim 6, wherein the verification task comprises verifying the email address data using an email verification message.

8. A distributed user profile identity verification system as claimed in claim 1, wherein the verification task comprises receipt of social user account data.

9. A distributed user profile identity verification system as claimed in claim 8, wherein the verification task comprises authenticating with a social media server associated with the social user account data.

10. A distributed user profile identity verification system as claimed in claim 9, wherein the verification task comprises retrieval of social graph data from a social user account associated with the social user account and wherein the verification task has as input the social graph data.

11. A distributed user profile identity verification system as claimed in claim 1, wherein each database further comprises user data.

12. A distributed user profile identity verification system as claimed in claim 11, wherein the at least one authentication server allows for user control of user data.

13. A distributed user profile identity verification system as claimed in claim 12, wherein user control of the content user data comprises configuring a publication setting.

14. A distributed user profile identity verification system as claimed in claim 13, wherein the publication setting configures the user data to be visible only to other users having a user profile record within the ledger.

15. A distributed user profile identity verification system as claimed in claim 14, wherein the publication setting configures the user data to be visible only to other users having a user profile record having a minimum verification threshold level within the ledger.

16. A distributed user profile identity verification system as claimed in claim 1, wherein the system is configured for receiving a user identity verification request and responding with a user identity verification response comprising at least a verification level.

17. A distributed user profile identity verification system as claimed in claim 16, wherein responding with a user identity verification response comprises serving a verification icon representing the verification level.

18. A distributed user profile identity verification system as claimed in claim 17, wherein the user identity verification request comprises receiving a user profile identifier.

19. A distributed user profile identity verification system as claimed in claim 18, wherein the user profile identifier comprises a user profile page identifier.

20. A distributed user profile identity verification system as claimed in claim 19, wherein the user profile identifier further comprises a user profile page web domain.

21. A distributed user profile identity verification system as claimed in claim 1, wherein the least one authentication server is configured for user configuration of the serving of the verification icon by web domain.

22. A distributed user profile identity verification system as claimed in claim 1, wherein the system further comprises at least one authentication server in operable communication with the ledger and wherein the authentication server is configured for receiving a user authentication request comprising a user profile identifier and searching for a matching user profile record within the ledger.

23. A distributed user profile identity verification system as claimed in claim 23, wherein the authentication server is further configured for retrieving the verification level associated with the matching user profile record and authenticating in accordance with the verification level.
